(19) United States
(12) Patent Application Publication
(10) Pub. No.: US 2008/0127644 A1
(43) Pub. Date: Jun. 5, 2008

(54) Supercharging control for an internal combustion engine

(75) Inventors: Ennio Codan, Hausen bei Brugg (CH); Olivier Bernard, Baden (CH)

Correspondence Address: BUCHANAN, INGERSOLL & ROONEY PC, POST OFFICE BOX 1404, ALEXANDRIA, VA, 22313-1404, US

(73) Assignee: ABB Turbo Systems AG, Baden (CH)

(21) Appl. No.: 11/980,397

(22) Filed: Oct. 31, 2007

Related U.S. Application Data
(63) Continuation of application No. PCT/CH2006/000229, filed on Apr. 26, 2006.

(30) Foreign Application Priority Data
May 4, 2005 (EP) 05405335.0

(51) Int. Cl. F02D 23/00

(52) U.S. Cl. 60/600; 123/306

(57) ABSTRACT

By means of a pre-swirl device, in steady-state engine operation, the rotational speed lines of the compressor are moved, by increasing the swirl at the compressor inlet in the rotational direction of the compressor, to such an extent that the steady-state operating point of the compressor comes to rest approximately at the absorption limit of the compressor. In this way, the level of the charge pressure can be adjusted in a controlled fashion to the value required for the respective engine operating point. In the event of a sudden increase in the engine load, it is possible by resetting the pre-swirl grate to generate a charge pressure increase without a time-consuming rotor acceleration. The pre-swirl device therefore simultaneously assumes the functions of charge pressure and engine load control.

### RELATED APPLICATIONS

This application claims priority under 35 U.S.C. §119 to EP Application 05405335.0 filed in European Patent Office on 4 May 2005, and as a continuation application under 35 U.S.C. §120 to PCT/CH2006/000229 filed as an International Application on 26 Apr. 2006 designating the U.S., the entire contents of which are hereby incorporated by reference in their entireties.

### TECHNICAL FIELD

The disclosure relates to the field of supercharged internal combustion engines. A control system for the charging of an internal combustion engine and a method for operating a supercharged internal combustion engine are disclosed.

### BACKGROUND INFORMATION

Supercharged internal combustion engines (e.g. gas-, gasoline- or diesel-fueled) which operate in a wide rotational speed and load range generally require at least two control systems: a main control which controls the engine power via the fuel supply, and an auxiliary control which can generate the required charging pressure of the supercharging system for every operating point.

While the control of air and fuel quantities can take place independently in a wide range in the case of diesel engines, in spark-ignition engines, the range of variation of the air/fuel ratio is very restricted. For this reason, the engine power control takes place practically by means of a single quantity control for the constant air/fuel mixture.

The most extreme demands are found in the case of small spark-ignition engines as are used for example in passenger motor vehicles. Typically provided here are a first control with a turbine-side overpressure valve (so-called “wastegate control”), by means of which the charge pressure in the engine rotational speed range of from for example 2000 to 6000 rev/min can be kept approximately constant, and a second control by means of a throttle flap, which throttles the charge pressure to the level which is required for the present engine operating point. The throttle flap simultaneously generates a reserve for acceleration. As long as the turbocharger delivers the maximum charge pressure and the throttle flap correspondingly throttles said maximum charge pressure, it is possible by opening the throttle flap to release the throttled charge pressure and realize an instant power increase. The known problem of turbo lag however occurs when the engine power is so low that, despite the closed overpressure valve (wastegate), the turbine of the exhaust gas turbocharger does not receive enough energy to deliver the maximum charge pressure. In this case, the turbocharger rotor must be accelerated before the required torque can be invoked from the internal combustion engine. This is particularly critical in the lower rotational speed range of the motor, for example between 1000-2000 rev/min.

In the past, various possibilities have been tested for raising the turbocharger rotational speed, by means of additional generation of swirl in the air flow at the inlet of the compressor of the exhaust gas turbocharger, in order to eliminate the problem of turbo lag.

In the case of large spark-ignition engines, which are used for example for power generation or for driving very large, stationary machines, the rotational speed range is very much smaller than in the case of passenger motor vehicle engines. Here, the engine efficiency plays a much more important role. The above-described types of pressure control, as well as all other conceivable types of pressure control, are associated with losses, as a result of which they are used to a very limited extend in large engines. For this reason, the supercharging system is designed for a small number of operating points in such a way that the charge pressure without control lies only slightly above the value required for the respective operating point. The charge pressure is then controlled by means of an exhaust gas wastegate, air wastegate or mixing recirculation in the compressor or variable turbine geometry or similar systems. The charge-pressure control cannot however be considered as power control. If specifically no charge pressure reserve is present, the engine reacts very slowly to small load changes, since the change in the turbocharger operating point as a result of the adjustment of the control element is always associated with a more or less large deceleration as a result of the inertia of the system. If the load steps become greater, intense braking of the engine can then occur, or the engine can even be completely stalled and shut down.

In most cases, even in the case of large engines, a throttle flap is then provided which assumes the task of ensuring fine and quick power control and at the same time installing a minimum pressure reserve. As described above, the load capacity of the engine increases with increasing pressure loss across the throttle flap, but at the expense of decreasing engine efficiency. The energy for overcoming the throttle flap pressure loss is extracted from the exhaust gas energy, that is to say the turbocharger turbine must be designed for a higher power, and this in turn increases the counterpressure for the cylinders of the engine.

EP 0 196 967 A illustrates a control of a pre-swirl device for a compressor of an internal combustion engine. Here, the blade position of the pre-swirl device is controlled according to a prescribed line as a function of the mass flow rate. Said control, is independent of the power control of the engine. The compressor characteristic map can therefore vary, and the various steady-state operating points can be improved. The power control of the engine is assumed entirely by the throttle flap. In the case, for example, of an acceleration of the engine, the throttle flap is opened and the air throughput increases. Only then is the swirl progressively depleted. The pressure reserve which is required for a good acceleration and which is available when the throttle flap is opened quickly can be much smaller with pre-swirl than without pre-swirl.

### SUMMARY

The object on which the disclosure is based is that of creating a control for an internal combustion engine which leads to an improved load capacity of the engine and not to a considerable loss of efficiency in steady-state operation.

A control system and a control method are disclosed, in which by means of a pre-swirl device, in steady-state operation of the internal combustion engine, the rotational speed lines of the compressor are moved, by increasing the swirl at the compressor inlet in the rotational direction of the compressor, to such an extent that the steady-state operating point of the compressor comes to rest approximately at the absorption limit of the compressor. In this way, the level of the charge pressure can be adjusted in a controlled fashion, directly and without additional throttling, to the value required for the respective engine operating point. Accordingly, in the event of a sudden increase in the engine load, it is possible by resetting the pre-swirl grate to generate a charge pressure increase without a time-consuming rotor acceleration.

The pre-swirl device therefore simultaneously assumes the functions of charge pressure and engine load control.

The load capacity of the engine is then at least as good as that of a heavily-throttled engine. Since the throttling is dispensed with, however, the engine efficiency in steady-state operation is as good as that of an unthrottled engine.

In the case of a load being shed, pumping of the compressor can be prevented by virtue of the pre-swirl being quickly increased.

In normal operation, therefore, a throttle flap becomes superfluous as a result of the pre-swirl device according to the disclosure, since the pre-swirl control also assumes the power control of the engine. The maximum swirl can be generated in every operating point of the engine, so that the compressor rotational speed in each case reaches the maximum possible value at the respective steady-state load point.

If more power is demanded of the engine (for example if the driver of a passenger vehicle presses the throttle pedal), the throttle flap is not opened, but rather the guide blades of the pre-swirl device open. As a result, the swirl at the inlet of the compressor is immediately depleted, and the compressor, as a result of the greatly increased rotational speed, immediately delivers a pressure which is considerably higher than in the case of an engine which is controlled conventionally by means of a throttle flap.

The inventive control system and control method is suited for several fuel type engines, such as but not limited to diesel-, gasoline- or fluid gas-fueled engines.

### BRIEF DESCRIPTION OF THE DRAWINGS

The disclosure is explained in more detail below on the basis of figures, in which:

FIG. 1 shows a section through the compressor inlet of an exhaust gas turbocharger having an adjustable pre-swirl device,

FIG. 2 shows a diagram of the charge-pressure control with a throttle flap,

FIG. 3 shows a diagram of the charge-pressure and power control with swirl at the compressor inlet, and

FIG. 4 shows a second diagram of the control as per FIG. 3 on the basis of the turbocharger rotational speed as a function of the engine power.

### DETAILED DESCRIPTION

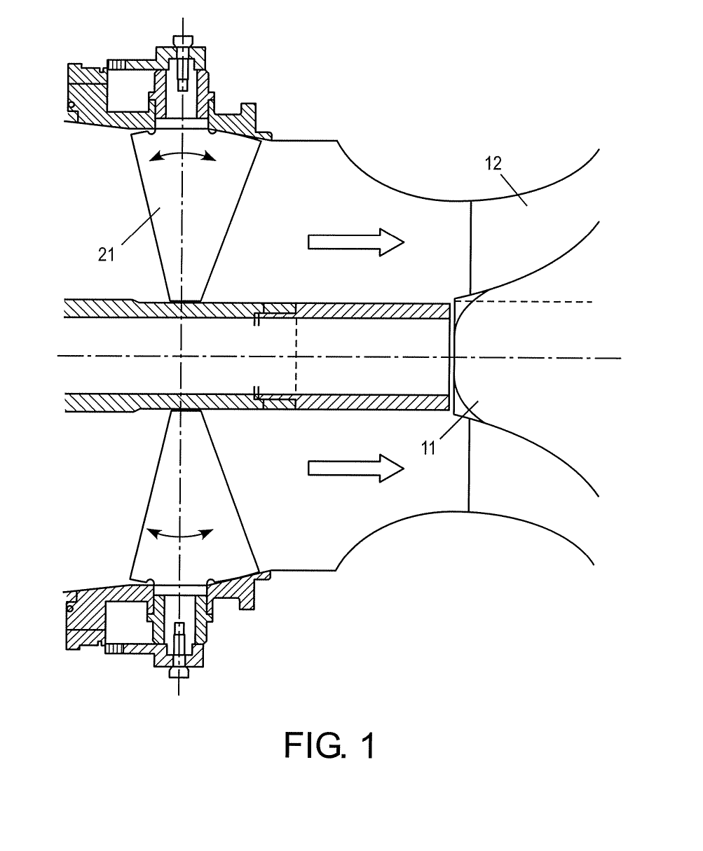

FIG. 1 shows a section through the compressor inlet of an exhaust gas turbocharger. The compressor wheel is indicated in a rudimentary fashion at the right-hand side. Said compressor wheel comprises a hub 11 and moving blades 12 which are fastened to the hub. Arranged in the intake region of the compressor is a pre-swirl device which comprises a plurality of guide blades 21. The guide blades are, in the illustrated embodiment, arranged radially with respect to the turbocharger shaft and can in each case rotate about an axis. A more or less intense deflection of the air flow is brought about depending on the alignment of the guide blades, so that said air flow is acted on with more or less swirl. The swirl can, if it is in the same rotational direction as the compressor wheel, lead to a reduction in the compressor drive power, and consequently, at constant turbine power, to an increase in the rotor rotational speed.

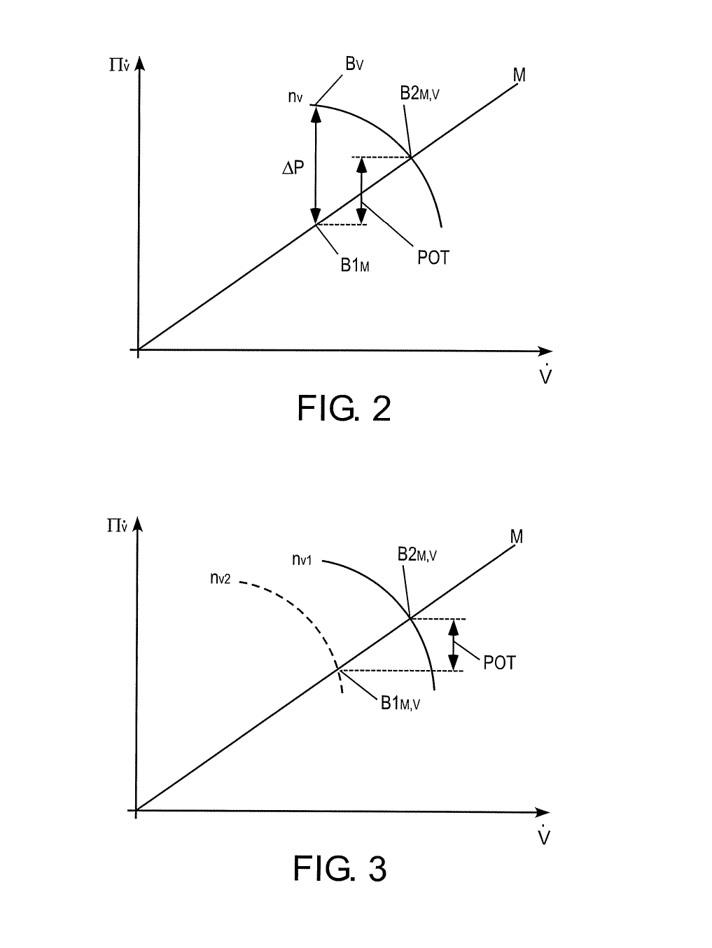

In steady-state operation of a throttled internal combustion engine, the work performed by the exhaust gas turbocharger is partially nullified by the throttling. The pressure which is reduced by means of the throttle flap serves as a reserve and can be immediately activated in the event of a load increase at the internal combustion engine. This prevents the air required for the load increase being available only after a rotational speed increase of the compressor. As can be seen from FIG. 2, proceeding from the operating point of the compressor B_{V}, as a result of throttling, such a quantity of pressure ΔP is depleted that the air requirement of the internal combustion engine is saturated right away. On the curve, this corresponds to the operating point of the internal combustion engine B1_{M}. If, during the said load increase, the throttling is then removed, the compressor is moved rapidly to the operating point B2_{M,V} and at least a part of the required additional air quantity is immediately available to the internal combustion engine. The corresponding potential for the power increase is indicated in the diagram by the arrow POT. The throttling therefore ensures a sudden load change, but at the expense of losses in steady-state operation.

The control according to the disclosure is different. In the steady state, a swirl in the rotational direction of the compressor is generated by means of the pre-swirl device. The swirl at the inlet of the compressor wheel results on the one hand in an additional increase in the compressor rotational speed. On the other hand, the swirl however has the result that, on the characteristic curve diagram as per FIG. 3, the rotational speed line (curve n_{V2}) of the compressor with pre-swirl is moved to the left in relation to the rotational speed line (curve n_{V1}) of the compressor without swirl. Here, such an amount of swirl is generated that the operating point of the compressor coincides B1_{M,V} with the operating point of the internal combustion engine. Here, said operating point comes to rest close to the absorption limit of the compressor. This takes place, at least over most of the steady-state operating range of the internal combustion engine, without throttling and accordingly also without throttling losses. Only in the lower load range, in particular at idle of the engine, can throttling bring further advantages in addition to the device according to the disclosure.

In the event of a sudden increase in engine load, it is now possible in the control system according to the disclosure for the guide blades of the pre-swirl device to be reset, such that the pre-swirl which is generated is reduced or eliminated entirely. The no longer present swirl at the inlet of the compressor leads to the rotational speed line on the characteristic curve diagram returning to its initial position (curve n_{V1}). Without the rotational speed of the compressor changing, at the operating point B2_{M,V}, the required additional air is available to the internal combustion engine. Like in the case of throttled engines, it is possible with the control according to the disclosure to generate a charge-pressure increase without a time-consuming rotor acceleration. However, in the case of the control according to the disclosure with the pre-swirl device, there are no power losses in steady-state operation of the internal combustion engine before a load increase.

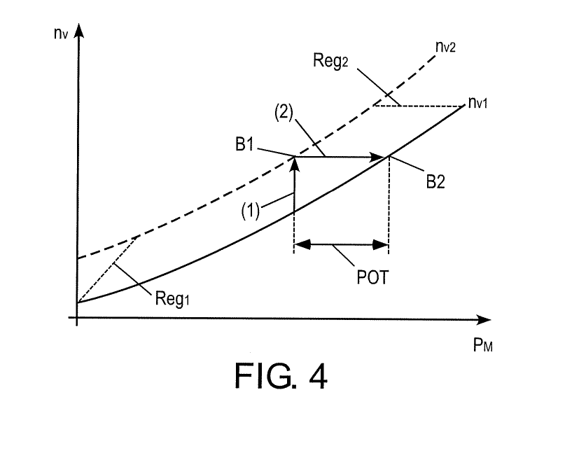

The profile of the load increase by means of the control system according to the disclosure is highlighted again in FIG. 4 on the basis of a rotational speed diagram. The curve n_{V1} represents the minimum required compressor rotational speed for generating the charge pressure associated with the engine power (P_{M}). By generating a pre-swirl, the rotational speed of the compressor in steady-state operation is increased (arrow (1) to curve n_{V2}). Proceeding from said operating point B1, the swirl is depleted in the event of a load increase (arrow 2). Additional air for the power increase is available to the internal combustion engine without it being necessary to increase the compressor rotational speed.

In the lower load range, in particular at idle of the engine, it is normally necessary to lower the pressure upstream of the inlet valves of the engine far below ambient pressure. If this is realized by means of the pre-swirl device, the entire compressor stage is in a vacuum. In a conventional turbocharger, this would have the result of lubricating oil being sucked from the bearing space into the air space of the compressor. This can be counteracted by means of improved sealing. Alternatively, it is however also possible to ensure by means of a throttle flap that the pressure at the compressor outlet does not fall below a certain limit value. If the pressure upstream of the throttle flap falls below said limit value, the throttle flap is closed slightly, and said limit value is thus adhered to. This would reduce the engine power. The engine controller would however detect this and automatically set the correct pressure downstream of the throttle flap again by opening the pre-swirl grate. As a limit value, it is possible to use the ambient pressure or preferably a slight vacuum, depending on the oil sealing possibilities. Said additional control results for example in the rotational speed profile Reg₁ in FIG. 4.

In the uppermost load range, it is possible with the proposed control for the turbocharger speed to reach excessive values. If the nominal engine power is so high that the permissible turbocharger rotational speed is exceeded as a result, the throttle flap must, similarly to the preceding case, be utilized to keep the turbocharger rotational speed at a maximum value. Said additional control results for example in the rotational speed profile Reg₂ in FIG. 4.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

11 Compressor wheel, hub
12 Compressor wheel, moving blades
21 Swirl device, rotatable guide blades
B_{M} Engine operating point
B_{V} Compressor operating point
B1 Operating point before load increase
B2 Operating point after load increase
M Internal combustion engine air demand
n_{V} Rotational speed or rotational speed line of the compressor
n_{V1} Rotational speed or rotational speed line of the compressor, without swirl
n_{V2} Rotational speed or rotational speed line of the compressor, with swirl
Π_{\dot{V}} Pressure ratio of the compressor
\dot{V} Intake air quantity
ΔP Throttling
P_{M} Power of the internal combustion engine
POT Potential for power increase
Reg₁ Vacuum control
Reg₂ Excessive rotational speed control

What is claimed is:

1. A control system for controlling a supercharged internal combustion engine, with the control system comprising a power control for controlling the internal combustion engine power and a charge-pressure control for controlling the exhaust gas turbocharger charge pressure, wherein
the power control of the internal combustion engine and the charge-pressure control for controlling the exhaust gas turbocharger charge pressure are carried out by a single control system, and wherein
the control system controls the power of the internal combustion engine and the charge pressure of the exhaust gas turbocharger by means of the pre-swirl at the compressor inlet.

2. The control system as claimed in claim 1, wherein the control system controls the power and the charge pressure over the entire power range of the internal combustion engine with the exception of idle and the power range close to idle.

3. The control system as claimed in claim 2, wherein the system comprises a throttle flap, and in that the charge pressure can be controlled in the region of a minimum value by means of a throttle flap.

4. The control system as claimed in claim 2, wherein the system comprises a throttle flap, and in that the rotational speed of the exhaust gas turbocharger can be controlled in the region of a maximum value by means of a throttle flap.

5. An internal combustion engine with an exhaust gas turbocharger and a control system for controlling the internal combustion engine, with the control system comprising a power control for controlling the internal combustion engine power and a charge-pressure control for controlling the exhaust gas turbocharger charge pressure, wherein
the power control of the internal combustion engine and the charge-pressure control for controlling the exhaust gas turbocharger charge pressure are carried out by a single control system, and wherein
the control system controls the power of the internal combustion engine and the charge pressure of the exhaust gas turbocharger by means of the pre-swirl at the compressor inlet.

6. The internal combustion engine as claimed in claim 5, wherein the control system controls the power and the charge pressure over the entire power range of the internal combustion engine with the exception of idle and the power range close to idle.

7. The internal combustion engine as claimed in claim 6, wherein the system comprises a throttle flap, and in that the charge pressure can be controlled in the region of a minimum value by means of a throttle flap.

8. The internal combustion engine as claimed in claim 6, wherein the system comprises a throttle flap, and in that the rotational speed of the exhaust gas turbocharger can be controlled in the region of a maximum value by means of a throttle flap.

9. A method for operating a supercharged internal combustion engine, wherein in the steady-state operating mode, the steady-state operating point of the compressor comes to rest in the region of the absorption limit by increasing the swirl of the air which is supplied to the compressor of the exhaust gas turbocharger, and wherein, in the event of a load increase of the internal combustion engine, a deceleration-free charge-pressure increase is obtained by reducing the swirl.

10. The control system as claimed in claim 3, wherein the system comprises a throttle flap, and in that the rotational speed of the exhaust gas turbocharger can be controlled in the region of a maximum value by means of a throttle flap.

11. The internal combustion engine as claimed in claim 7, wherein the system comprises a throttle flap, and in that the rotational speed of the exhaust gas turbocharger can be controlled in the region of a maximum value by means of a throttle flap.

12. A method for operating a supercharged internal combustion engine, comprising:
supplying a swirl of air to a compressor of an exhaust gas turbocharger in order to reach an absorption limit of a steady-state operating point of the compressor; and
in the event of a load increase of the internal combusion engine, reducing the swirl to obtain a deceleration-free charge-pressure increase.
